(19) United States
(12) Patent Application Publication
(10) Pub. No.: US 2021/0174991 A1
(43) Pub. Date: Jun. 10, 2021

(54) INSULATOR HAVING AN END FITTING AND A CONNECTING DEVICE AS WELL AS ARRANGEMENT FOR DISSIPATING OVERVOLTAGE

(71) Applicant: SIEMENS ENERGY GLOBAL GMBH & CO. KG, MUENCHEN (DE)

(72) Inventors: MAJA JOLIC, BERLIN (DE); FLORENT GIRAUDET, BERLIN (DE); THOMAS KOCH, BRIESELANG (DE); ALEXANDER BOCKAREV, BERLIN MARZAHN-HELLERSDORF (DE); BASTIAN ROBBEN, BERLIN (DE)

(21) Appl. No.: 17/270,128

(22) PCT Filed: Jul. 22, 2019
(86) PCT No.: PCT/EP2019/069623

§ 371 Date: Feb. 22, 2021

(30) Foreign Application Priority Data
Aug. 21, 2018 (DE) 10 2018 214 053.7

(51) Int. Cl. H01B 17/06; H01B 17/38; H01B 17/46; H01T 4/14; H02G 7/05

(52) U.S. Cl. CPC H01B 17/06; H01B 17/38; H02G 7/05; H01T 4/14; H01B 17/46

(57) ABSTRACT

An insulator includes an end fitting and a connecting device disposed on the end fitting for connecting the insulator to a suspension device. The insulator also includes an additional operating device. The end fitting and the connecting device are formed in one piece. An arrangement is also provided for dissipating overvoltage using the insulator according to the invention.

The invention relates to an insulator according to the precharacterizing clause of claim 1 and an arrangement according to claim 11.

Composite long-rod insulators are known, for example, from the product brochure “Silikon-Langstabisolatoren 3FL für Mittel- and Hochspannungsfreileitungen”, [“3FL Silicone long-rod insulators for medium- and high-voltage overhead lines”] Siemens AG 2011, Order No. E50001-G630-A193. The long-rod insulators have a rod made from glass fiber reinforced plastics (GFP), to the ends of which a metal end fitting is applied in each case. A silicone sheath with shields for creepage path extension is provided as the housing. The end fittings can have a multiplicity of different forms at their end remote from the housing. These forms are provided for connecting or suspending the insulator and are described in standards IEC 61466-1, IEC 60120 and IEC 60471. Typical forms according to page 5 are ball, socket, joint fork, joint plate, Y-fork and eye.

An insulator is protected from corona effects and short-circuit arcs with the aid of protective rings. Such protective fittings are connected to the insulator, i.e. connected to an end fitting, via additional fittings. These connections between the insulator and additional fittings are generally supported flexibly in order to not transmit bending stresses to the insulator. For example, a line arrester with an external spark gap can be connected to the insulator via additional fittings. Such externally gapped line arresters (EGLA) are known, for example, from pages 10 and 11 of the product brochure “Leitungsableiter für erhöhte Systemzuverlässigkeit” [“Line arresters for increased system reliability”], Siemens AG 2012, Order No. E50001-G630-A203.

The object of the invention is to specify an insulator which can be connected to an operating means in a particularly simple and reliable manner.

The invention achieves this object by means of an insulator according to claim 1.

The invention is based on the problem of there being applications in which the operating means should be supported on the insulator in a fixed, movement-free manner. This is the case, for example, if a spacing of the protective rings from the center of the insulator is to be constant or if other protective devices, for example a line arrester, are to be installed. In this case, within the context of the invention, fixed in a movement-free manner means mounted without degrees of freedom. In particular, in the case of a line arrester with an external spark gap, all degrees of freedom are to be eliminated in order to keep the length of the spark gap constant, even in the event of a movement of the insulator, for example due to vibrations caused by wind.

In the prior art, combinations of a joint fork with an additional fitting with a plate have been hitherto provided. In this case, the fitting is geometrically designed such that the plate rests extensively in the fork and is therefore fixed in place. This requires a high degree of precision during manufacture. Moreover, this design is never free of movement. The invention solves this problem by means of the single-piece design, in which the end fitting is combined with the connecting device. Two components are therefore replaced by a single component, which eliminates all degrees of freedom of this connection. The position of the attached components is fixed. A further advantage is that it saves on material and the installation effort is reduced.

In a preferred embodiment of the inventive method, the insulator is a long-rod insulator. This is an advantage since long-rod insulators are time-tested and widely used.

In a preferred embodiment of the inventive method, the connecting device has a contact portion for mounting the additional operating means. This is advantageous since simple fastening of additional parts to the end fitting is possible by means of the contact portion.

In a further preferred embodiment of the inventive method, the contact portion has at least one cutout for attaching the additional operating means. This is an advantage since a guiding-through of a fastening means, for example a bolt or a screw with a nut, is enabled by the cutout. This contributes to slip-free attachment.

In a preferred development of the above-mentioned embodiment, the contact portion has at least two boreholes for attaching the additional operating means. This is an advantage since two screws with nuts for fastening purposes can be used as a result of the boreholes.

In a further preferred embodiment of the inventive method, the connecting device has a suspension portion with a means for suspending the insulator. This is an advantage since insulators are often used on masts for high-voltage overhead lines. In this case, a suspended attachment is often used in order to prevent bending loads on the insulator as a result of vibrations of the mast or wind affecting the insulator.

In a preferred development of the above-mentioned embodiment, the suspension portion has at least one of the following forms: ball, socket, joint fork, joint plate, Y-cable, eye. Numerous different means of suspension can therefore be selected as required.

In a further preferred embodiment of the inventive insulator, the end fitting with the connecting device consists substantially of metal. This is preferably steel or aluminum. This is an advantage since using a metal end fitting is cost-effective in terms of production and the metal end fitting is robust and durable.

In a further preferred embodiment of the inventive insulator, the end fitting with the connecting device is produced in one piece in a casting process. This is an advantage since metal workpieces in virtually any desired form can be produced in a simple and cost-effective manner by means of a casting process.

The invention is furthermore based on the object of specifying an arrangement for dissipating overvoltage, which can be installed in a particularly simple manner and is comparatively reliable.

The invention achieves this object by means of an arrangement according to claim 11. Preferred embodiments of the inventive arrangement are revealed in claims 12 to 15. Essentially the same advantages as those explained at the outset for the inventive method are revealed for the inventive arrangement and its embodiments.

For better explanation of the invention, in a schematic illustration:

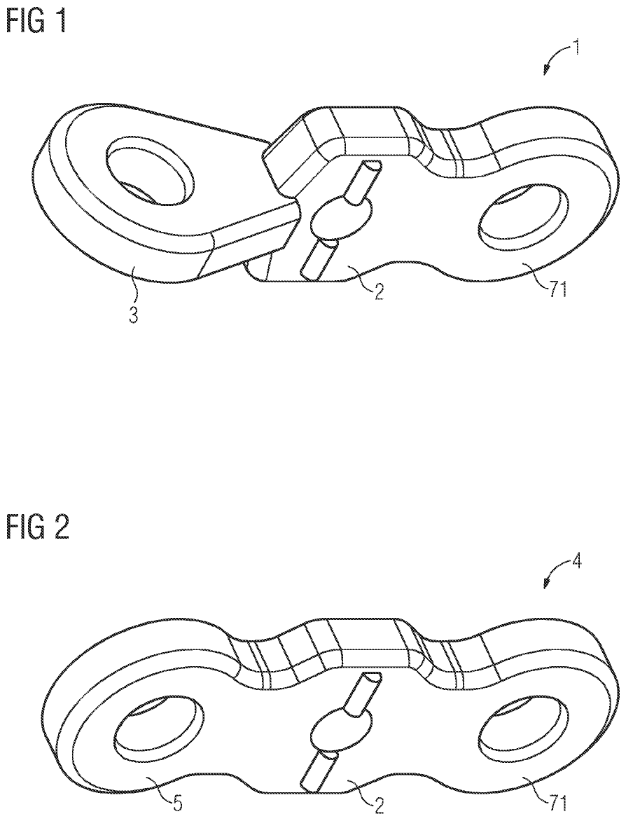

FIG. 1 shows a first known connecting device; and

FIG. 2 shows a second known connecting device; and

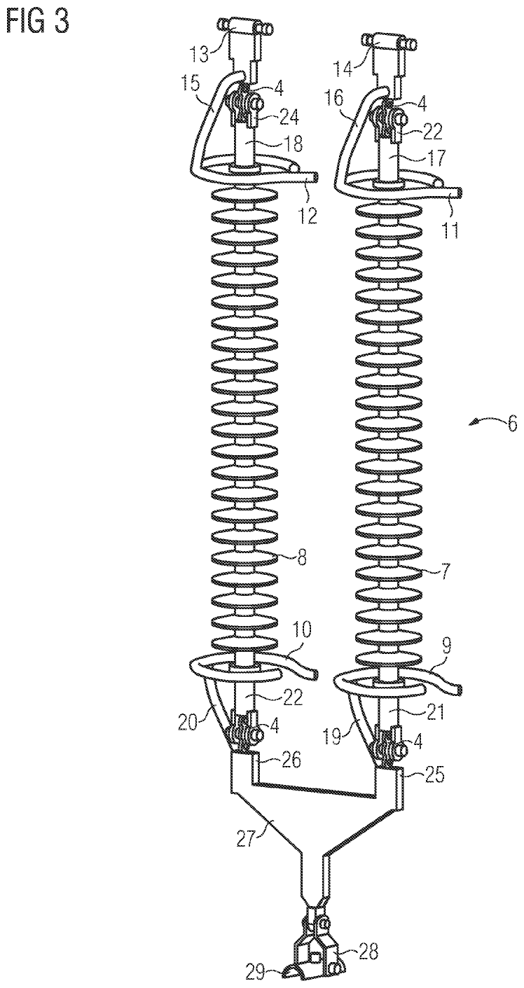

FIG. 3 shows a known arrangement with two insulators; and

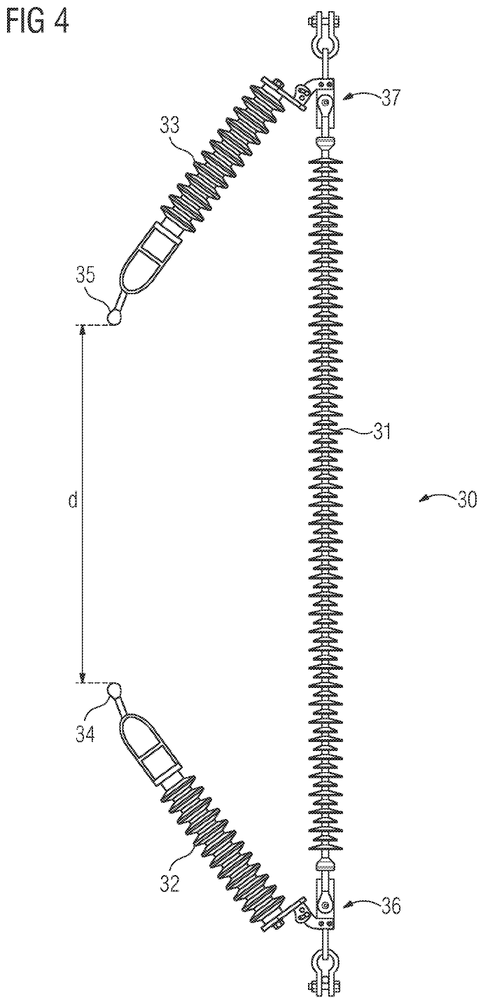

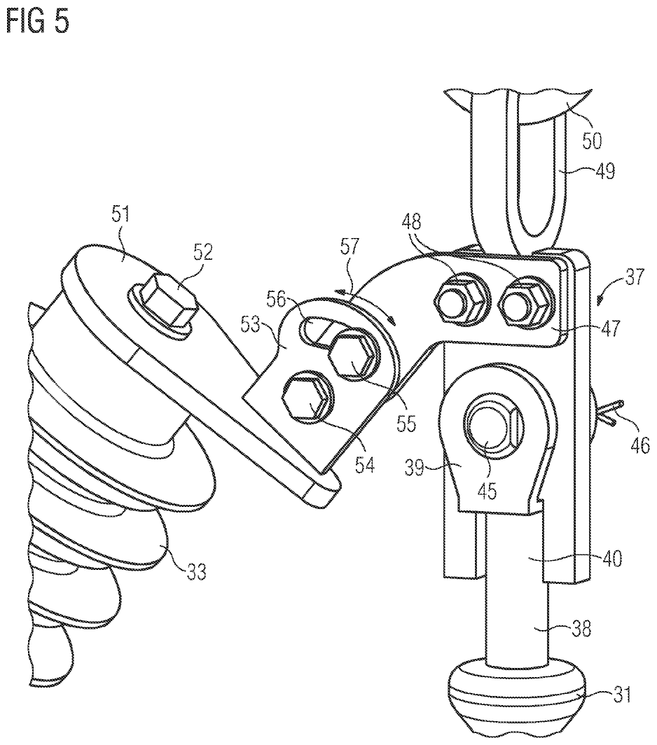

FIG. 4 shows a further known arrangement with an insulator and two overvoltage arresters; and

FIG. 5 shows a detailed view of the known arrangement according to FIG. 4; and

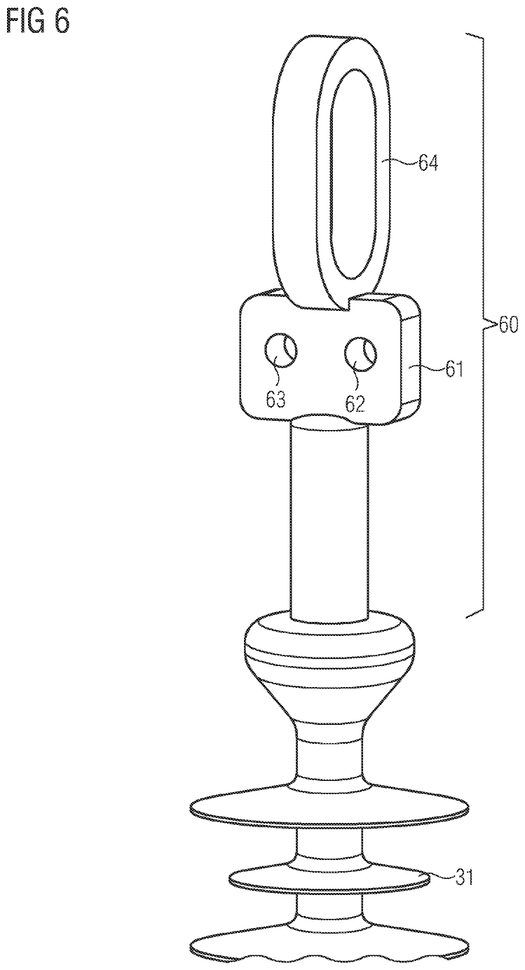

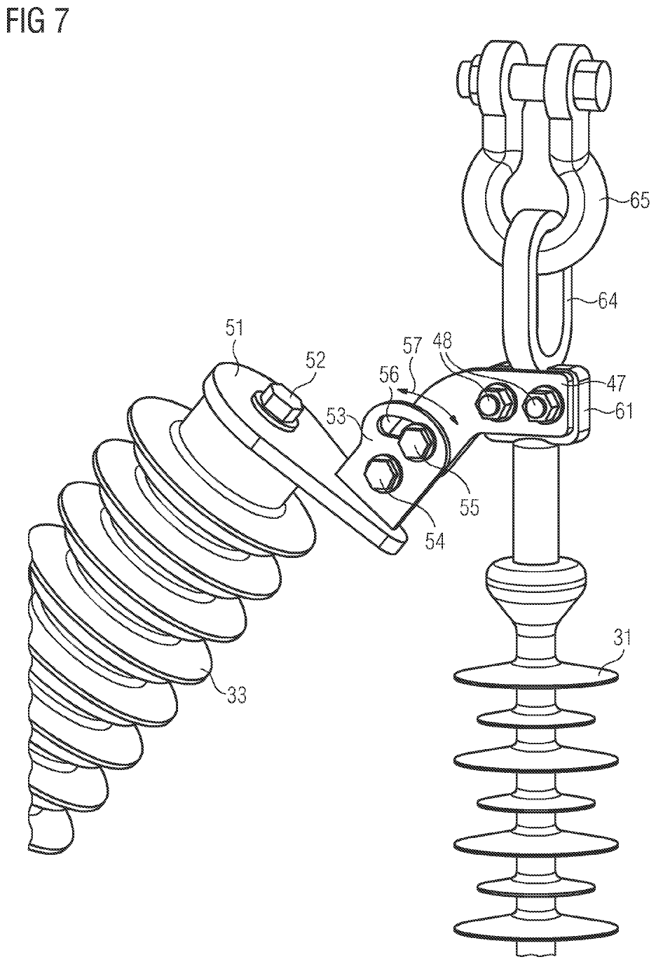

FIG. 6 shows an exemplary embodiment of the inventive insulator; and

FIG. 7 shows an exemplary embodiment of an inventive arrangement with an insulator.

FIG. 1 shows a connecting device 1 with a first eye 71, a contact portion 2 for mounting an additional operating means and a second eye 3. In this case, the eyes 3, 71 are formed as substantially flat metal rings, wherein the planes of the substantially flat metal rings are perpendicular to one another. On the other hand, in the second example for a connecting device 4 according to FIG. 2, the eyes 5, 71 are arranged in one plane. The connecting device 1 according to FIG. 1 enables an insulator to be mounted by means of the eye 71, for example, and enables this insulator to be mounted on a mast by means of the eye 3 such that it is rotated through 90 degrees in relation to the suspension device. This enables an orientation of the further operating means mounted on the contact portion 2. This is not the case in FIG. 2: this connecting device 4 arranges the mast suspension device and the insulator in the same orientation, and therefore also the connected further operating means.

FIG. 2 shows an arrangement 6, known in the prior art, with two long-rod insulators 7, 8. The long-rod insulators are connected to protective fittings 11, 12 via connecting devices 22, 24, which are mounted on the respective end fittings 17, 18 of the insulators 7, 8. The protective fittings 11, 12 are corona rings and have webs 15, 16. The connecting devices 22, 24 are moreover connected to mast attachments 13, 14 in each case. On the side of the insulators 7, 8 which is situated at the bottom corresponding to the suspension direction, the respective end fittings 21, 22 are in turn connected to corona rings 9, 10 via connecting devices 25, 26 and webs 19, 20. A spacer 27 in a substantially Y-shaped arrangement is provided to prevent a clashing together of the suspended insulators 7, 8. This spacer 27 is in turn connected via a connecting device 28 to a conductor fitting 29 for connection to an overhead line conductor (not illustrated).

In the known arrangement 6, the connecting devices 22, 24, 25, 26 are used to provide a certain flexibility in the suspension of the insulators 7, 8 and to therefore prevent the transmission of bending stresses to the long-rod insulators 7, 8.

FIG. 4 shows a known arrangement 30 with a long-rod insulator 31. The long-rod insulator 31 is connected to two arms 32, 33 in each case via inventive connecting devices 36, 37. The arms 32, 33 each support an overvoltage arrester and a spark horn 34, 35 so that an isolating distance of length D is provided in air between the spark horns 34 and 35. This arrangement provides a so-called externally gapped line arrester (EGLA).

FIG. 5 shows a detail in the region of the inventive connecting device 37. The arrester on the arm 33 is connected via a base plate 51, which is mounted by means of a screw 52. On the base plate 51, an attachment bar 53 projects at a perpendicular angle to this base plate 51. This attachment bar 53 has two bores for receiving screws 54, 55. In this case, one bore is formed as a slot 56 so that a rotation of the base plate in a plane which is vertical (with respect to the ground) is enabled after the positioning of the screw 55 in the slot 56. This enables the isolating distance D to be be adjusted and fixed in terms of its length. In this case, the arrow 57 denotes the direction of rotation along the opening specified by the slot 56. The screws 54, 55 attach the base plate 51 and the attachment bar 53 to a holding web 47. The holding web 47 has a portion which is bent in the direction of the base plate 51 and a portion which extends horizontally (parallel to the ground). This horizontal portion has two bores for receiving screw connections 48. The screw connections 48 enable fixing to the connecting device 37. The connecting device 37 is notable in that it provides a suspension device for the end fitting 38 of the insulator 31. This suspension device is formed in that the one 39 at the end of the end fitting 38 can be inserted into a cutout 40 of the connecting device 37. In this case, the fork 39 extensively encompasses the connecting device 37, formed substantially as a flat metal piece, so that, when fixed in place accordingly by means of a screw 45 and a securing clip 46, there are only very few movement options for the end fitting 38 with the fork 39 in the holder of the connecting device 37. Better stability of the length of the isolating distance D is thus achieved in the prior art, even when wind loads act on the insulator 31. The connecting device 37 furthermore has an eye 49 for grasping a mast suspension device 50.

FIG. 6 shows an inventive connecting device 60 of a long-rod insulator 31. The connecting device 60 has an end fitting, which, in one piece, contains the connecting device for mounting a further operating means and for suspension on a mast. To this end, the end fitting has a contact portion 61, arranged approximately centrally, for mounting the additional operating means or a holding web for the arrester. The contact portion 61 has two bores 62, 63 for fixing a holding web in place. An eye 64 for the attachment of a mast suspension device is furthermore provided. A substantial advantage of this exemplary embodiment is that, in contrast to previous insulator fittings and connecting devices, degrees or freedom and therefore vibrations are no longer possible. The fork and the corresponding cutout in the known device according to FIG. 5 are omitted. This saves on material and reduces costs.

FIG. 7 shows the inventive end fitting with the connecting device 60 in connection with the otherwise known components of the EGLA according to FIGS. 4 and 5. The same components are denoted by the same reference signs. The eye 64 of the connecting device is connected to a mast suspension device 65.

1-15. (canceled)

16. An insulator, comprising:
an end fitting;
a connecting device disposed on said end fitting for connecting the insulator to a suspension device;
said end fitting and said connecting device being formed in one piece; and
an additional operating device.

17. The insulator according to claim 16, wherein the insulator is a long-rod insulator.

18. The insulator according to claim 16, wherein said connecting device has a contact portion for mounting said additional operating device.

19. The insulator according to claim 18, wherein said contact portion has at least one cutout for attaching said additional operating device.

20. The insulator according to claim 19, wherein said at least one cutout includes at least two boreholes for attaching said additional operating device.

21. The insulator according to claim 16, wherein said connecting device has a suspension portion with a device for suspending the insulator.

22. The insulator according to claim 21, wherein said suspension portion is at least one of a ball, a socket, a joint fork, a joint plate, a Y-fork or an eye.

23. The insulator according to claim 18, wherein said connecting device has a spacing portion spacing said contact portion from a housing of the insulator.

24. The insulator according to claim 16, wherein said end fitting and said connecting device are formed of metal.

25. The insulator according to claim 16, wherein said end fitting and said connecting device are formed as a one-piece casting.

26. An arrangement for dissipating overvoltage, the arrangement comprising:
an insulator according to claim 16 having ends;
a first arm disposed at one of said ends of said insulator, said first arm having an overvoltage arrester;
a second arm disposed at another of said ends of said insulator, said second arm establishing an isolating distance from said second arm to said first arm in air; and
said first and second arms being fastened to said insulator in such a way as to prevent a change in a length of said isolating distance upon a movement of said insulator.

27. The arrangement according to claim 26, wherein said second arm has an overvoltage arrester.

28. The arrangement according to claim 26, wherein said insulator has two end fittings, each of said end fittings has a connecting device with a contact portion, and a respective one of said arms is fastened in a fixed manner to each of said contact portions.

29. The arrangement according to claim 28, wherein said contact portions have at least one cutout, and each said at least one cutout is configured for attaching a respective one of said arms.

30. The arrangement according to claim 28, wherein each of said contact portions has at least two boreholes and each of said boreholes is configured for attaching a respective one of said arms.
